(19) United States
(12) Patent Application Publication
(10) Pub. No.: US 2013/0056651 A1
(43) Pub. Date: Mar. 7, 2013

(54) ADVANCED ANTIMATTER WEAPON TECHNOLOGIES

(71) Applicant: Jake A. Todd, Seattle, WA (US)

(72) Inventor: Jake A. Todd, Seattle, WA (US)

(21) Appl. No.: 13/225,419

(22) Filed: Sep. 3, 2011

(51) Int. Cl. G21K 5/00

(52) U.S. Cl. 250/492.1

(57) ABSTRACT

A gamma ray emitting technology is described. It creates pair production in the enemy target and the positrons annihilate the electrons in the target. This causes the atoms of the target to lose their chemical bonds with each other. This technique is continued until the target is neutralized. Targets, which can be neutralized, include everything from a single enemy soldier, to a large battleship. The information in this abstract is not meant to limit the scope of the claims in any way.

### BACKGROUND

### Prior Art

### Non-Patent Literature Documents

http://en.wikipedia.org/wiki/Pair_production
http://en.wikipedia.org/wiki/Induced_gamma_emission

### M. RAGHEB, 2005-09-10, XRAY AND GAMMA RAY LASERS

### DETAILED DESCRIPTION

The present invention works, basically speaking, by generating positrons (the antimatter partner of electrons) on the target. The positrons annihilate the electrons in the atoms of the target, along with producing damaging gamma ray radiation. The present invention excites atoms inside the present invention, and then allows those atoms to radiate gamma rays, which create antimatter on, and inside the target.

When the target's atoms are stripped of their electrons, they can no longer maintain their chemical bonds to the atoms they were bonded with. This basically makes the atoms of the target fall apart, and out of the way, as the antimatter penetrates deeper into the target until enough damage has been done to eliminate the target. If one hole, or incision in the target is not enough to neutralize the target, then, very easily, more holes or incisions can be made at a very high speed.

The present invention could be attached to a plane, and used against air and ground targets. You could attach the present invention to a satellite and use it against other satellites, or anything such as ICBMs. The present invention could be an anti-personnel weapon, cutting quickly through the body armor of soldiers. Also, in that context, many human targets could be eliminated at once by locking on to an advancing group of soldiers.

The present invention could be attached to an unmanned vehicle and used against any target it comes across. Naval ships could employ the weapon to sea, ground, and air targets. Perhaps even submarines could employ the present invention. One example of that is a submarine releasing an embodiment of the present invention, which floats to the surface, and then destroys targets from there.

The present invention could be used to setup an incredibly secure perimeter for any military (or otherwise) installation. The present invention could also be used for covert ops, although the weight of the present invention may make it unfeasible for carrying in a backpack. However, this contingency should not be ruled out until full engineering contemplations have been explored.

Tanks or other vehicles could carry the present invention to be used on any land or air target. Projectile weapons, such as a modified missile could carry the present invention to eliminate ground, sea, and air targets. In this context, you would probably want the modified missile to detonate after it has completed its' mission, in order to prevent enemies from gaining knowledge of the technology. Alternatively, you could have the modified missile return to a secure location and then release a parachute in order to bring it safely home, with the advantage of refueling, and using the modified missile again.

Satellites, especially low-orbit ones, may even be able to effectively eliminate ground targets from their orbital position. Water torpedoes could also be eliminated using the present invention. If one sample of suitable atoms is not able to eliminate targets quickly enough, multiple banks of atoms could be simultaneously (or consecutively) excited in order to solve this improbable limitation.

The present invention could also be used as a “trojan horse”—that is, it could be camouflaged, and inserted behind enemy lines before going to work. It could be controlled remotely, for example only neutralizing targets during the night, when no one is going to notice what is happening.

Additionally, this is an excellent idea for use in many applications (to use in darkness), so that the enemy has no idea what type of technology is being used. (You could use it at night, remove neutralized targets, and the next day the enemy would simply know that some of their assets have disappeared.)

The present invention could be installed underground, for example, at a location where you know enemies will traverse. Remotely operated, the present invention could raise up from the ground, neutralize all targets (perhaps from behind them), and then retract into the ground, never to be known about.

The present invention could be installed on a small boat. This small boat could then be driven towards an enemy battleship. The people on the small boat would wave and smile. All this would convince the battleship that the small boat is no threat. Then, when the small boat has neared the battleship, the present invention could go to work demolishing the battleship. The small crew, perhaps just one person waving the enemy's flag, would be protected because the present invention could neutralize any personnel on the deck of the battleship who might fire on the small boat. The small boat, perhaps unmanned, could even approach at night, causing the battleship's personnel to think the small boat is just a large sea creature.

It's important for allied troops and vehicles to be protected, because when annihilation of an electron and a positron occurs, two potentially dangerous gamma rays are released. However, protection is relatively easy to accomplish. Firstly, the gamma rays coming from annihilation of the target's electrons will be going in all directions (and helping to destroy the target as well). Since the gamma rays are going in all directions, it is highly exponentially less dangerous to be watching the destruction happen than to be the target. However, damage can still happen to allied forces. But, simply crouching behind 12 inches of packed soil is more than sufficient to protect personnel. Also, in the many embodiments of the present invention where there are no allied assets nearby, no precaution need be made.

Let us do a little math. How long would it take to cut through one cubic centimeter of iron, using the present invention? There are about 7.8 grams of iron in one cubic centimeter of iron. 1 pound equals 453 grams. 7.8 grams of iron is 1.7% of 453 grams of iron. 1 pound of iron has 10̂24 atoms in it. 1 atom of iron has 26 electrons. 1.7% of 10̂24 atoms=1.7×10̂22 atoms. (1.7×10̂22)×26 electrons=4.42×10̂23 electrons. You need about 1.02 MeV per gamma ray in order to create a positron in the target. The amount of MeV you put into the present invention's atoms is the same amount of MeV you get out of them (in one embodiment of the present invention). If you can excite 1 mole (6.022×10̂23) of atoms in the present invention with an electromagnetic field, such that each atom in the present invention has absorbed about 1.02 MeV of energy, then the atoms in the present invention will radiate enough gamma ray energy to annihilate every single electron in one cubic centimeter of iron within about 1 picosecond. 1 picosecond is 10̂-12 seconds. That is 0.000000000001 seconds (virtually instantaneous).

With this understanding, you can see the awesome power of the present invention. Within a few seconds, if properly engineered, the present invention could neutralize an entire battlefield of enemies, including personnel, tanks, other vehicles, and aircraft such as helicopters. A good coolant system is important for the present invention. The information in this detailed description is not meant to, in any way, limit the scope of the claims.

I claim:

1. A method, for neutralizing hostile targets using electron positron annihilation through pair production, comprising:
a) exciting nuclei with at least 1.02 MeV per nucleus,
b) allowing said nuclei to radiate their energy,
c) directing the radiated energy towards a hostile target,
d) allowing said radiated energy to create electron positron pairs in the hostile target,
e) allowing the positrons to annihilate electrons in the hostile target.

2. A method, for neutralizing hostile targets using electron positron annihilation through pair production, comprising:
a) exciting nuclear isomers with at least 1.02 MeV per nuclear isomer nucleus,
b) pumping a level or levels of integrated cross sections of said nuclear isomers with xrays,
c) directing the resultant energy emissions to a hostile target,
d) allowing the radiated energy to create electron positron pairs in the hostile target,
e) allowing the positrons to annihilate electrons in the hostile target.

3. The method, for neutralizing hostile targets using electron positron annihilation through pair production, of claim 1, further comprising:
a) said nuclei comprising tantalum, osmium, platinum, hafnium, zinc, and indium.

4. The method, for neutralizing hostile targets using electron positron annihilation through pair production, of claim 1, further comprising:
a) supplying a plurality of nuclei samples for use.

5. The method, for neutralizing hostile targets using electron positron annihilation through pair production, of claim 2, further comprising:
a) said nuclear isomers comprising tantalum, osmium, platinum, hafnium, zinc, and indium.

6. The method, for neutralizing hostile targets using electron positron annihilation through pair production, of claim 2, further comprising:
a) supplying a plurality of nuclear isomer samples for use.
